(19) United States
(12) Patent Application Publication
(10) Pub. No.: US 2012/0062521 A1
(43) Pub. Date: Mar. 15, 2012

(54) ACTIVE STYLUS

(75) Inventors: Soon-Sung Ahn, Yongin-city (KR); Ja-Seung Ku, Yongin-city (KR); Brent Jang, Yongin-city (KR)

(73) Assignee: Samsung Mobile Display Co., Ltd., Yongin-city (KR)

(21) Appl. No.: 13/103,005

(22) Filed: May 6, 2011

(30) Foreign Application Priority Data
Sep. 14, 2010 (KR) 10-2010-0089953

(51) Int. Cl. G06F 3/033

(52) U.S. Cl. 345/179

(57) ABSTRACT

An active stylus used in a mutual capacitive touch screen system is described. In one aspect, the active stylus includes a shielding unit formed to shield an electric field that forms a closed loop between input and output units of the active stylus, thereby overcoming of oscillation or a decrease in amplitude.

### CROSS-REFERENCE TO RELATED APPLICATIONS

This application claims priority to and the benefit of Korean Patent Application No. 10-2010-0089953, filed on Sep. 14, 2010, in the Korean Intellectual Property Office, the entire content of which is incorporated herein by reference.

### BACKGROUND

1. Field

An aspect of the present invention relates to a touch screen system, and more particularly, to an active stylus used in a touch screen system.

2. Description of the Related Technology

A touch screen panel is an input device that allows a user's instruction to be inputted by selecting an instruction content displayed on a screen of a display device or the like with a user's hand or object.

To this end, the touch screen panel is formed on a front face of the display device to convert a contact position into an electrical signal. Here, the user's hand or object is directly in contact with the touch screen panel at the contact position. Accordingly, the instruction content selected at the contact position is inputted as an input signal to the display device. Since such a touch screen panel can be substituted for a separate input device connected to a display device, such as a keyboard or mouse, its application fields have been gradually extended.

Touch screen panels are divided into a resistive overlay touch screen panel, a photosensitive touch screen panel, a capacitive touch screen panel, and the like. Recently, interest in a multi-touch screen system has been increased, in which multi-touch recognition is achieved through a touch screen panel.

Particularly, in the case of the capacitive touch screen panel, multi-touch recognition is achieved using a self capacitance method or mutual capacitance method. The multi-touch recognition is achieved using the principle that when one or more user's fingers come in contact with a surface of the touch screen panel, a change in capacitance formed in a sensing cell (node) positioned on the contact surface is detected by an electric field of a human body, thereby recognizing the contact position.

However, according to the capacitive touch screen panel, it is difficult to recognize a more precise contact position through the contact by the user's finger.

In order to solve such a problem, it may be considered to use a stylus having a sharp end. However, in the case of a passive stylus, a change in capacitance on a contact surface is extremely small, and therefore, it is difficult to detect a position. In the case of an active stylus that generates an electric field by itself, the generated electric field has influence not only on a sensing cell (node) of the touch screen panel, corresponding to an actual contact position, but also on other sensing cells (nodes) connected to the sensing cell, and therefore, it is impossible to detect the contact position.

### SUMMARY OF CERTAIN INVENTIVE ASPECTS

Embodiments provide an active stylus used in a mutual capacitance touch screen system, in which a shielding unit is formed to shield an electric field that forms a closed loop between input and output units of the active stylus, thereby overcoming a problem of oscillation or amplitude decrease.

According to one aspect, there is provided an active stylus for outputting an electric field in synchronization with a driving signal applied to a driving line coupled to an adjacent cell when the active stylus approaches or contacts a touch screen panel, the active stylus including: an electric field sensor as an input unit that senses an electric field generated by the driving signal applied to a specific driving line approached or contacted by the stylus, a signal generating unit that generates a predetermined signal so that a separate electric field corresponding to the sensed electric field is generated, an electric field radiating unit as an output unit that amplifies the signal generated from the signal generating unit and outputs the amplified signal as an electric field, a shielding unit that shields an electric field for forming a closed loop between the electric field sensor and the electric field radiating unit, and a power unit that applies power to each of the electric field sensor, the signal generating unit, the electric field radiating unit and the shielding unit.

### BRIEF DESCRIPTION OF THE DRAWINGS

The accompanying drawings, together with the specification, illustrate some embodiments, and, together with the description, serve to explain various aspects and features according to some embodiments.

FIG. 1 is a configuration block diagram of a touch screen system according to some embodiments.

FIG. 2 is a simplified circuit diagram of the touch screen panel shown in

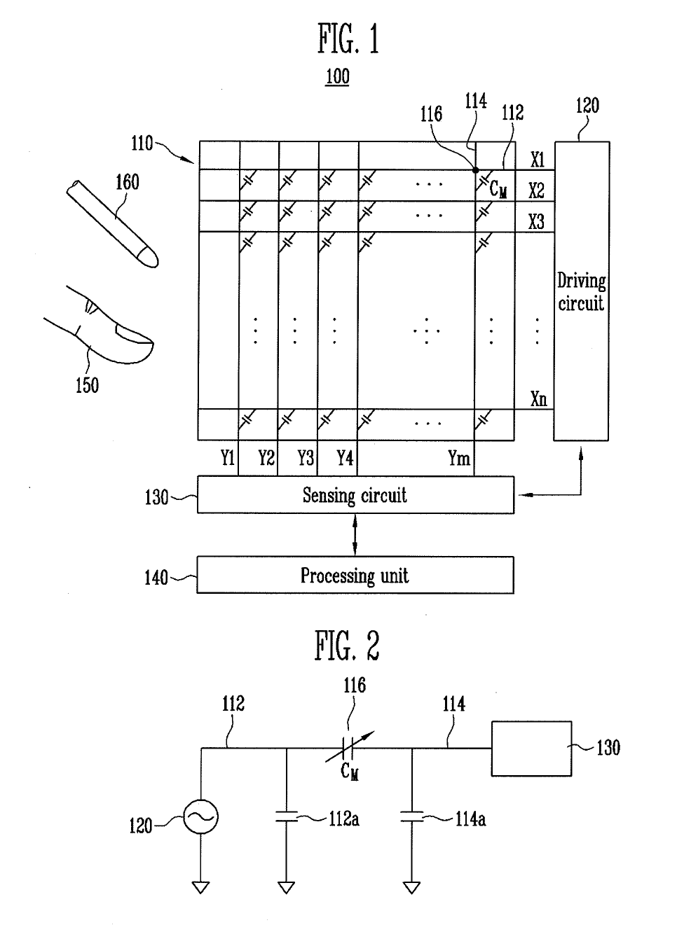

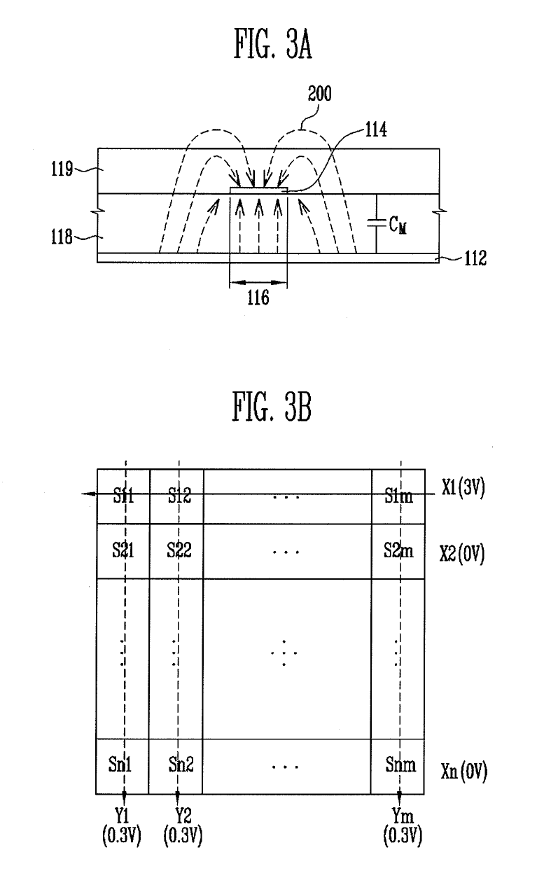

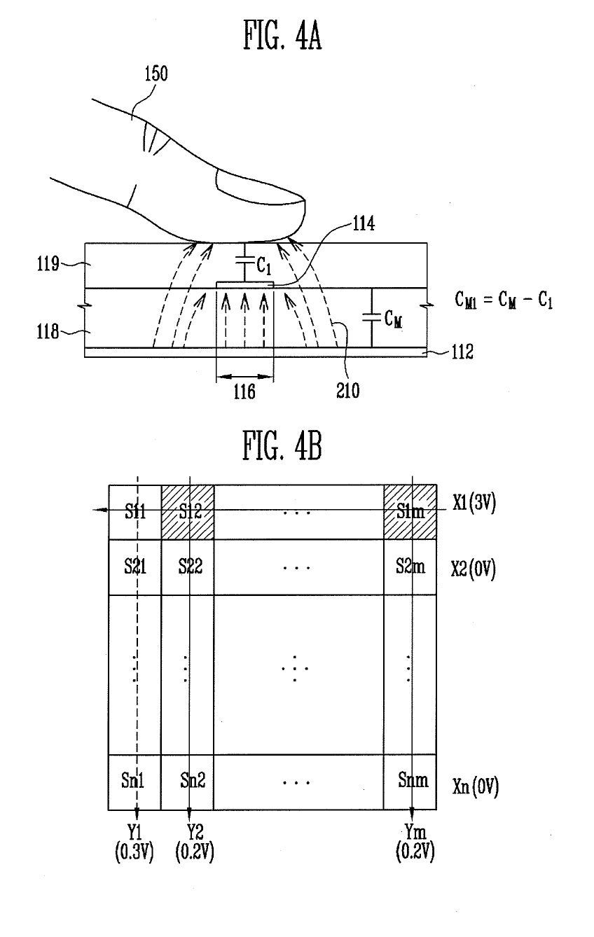

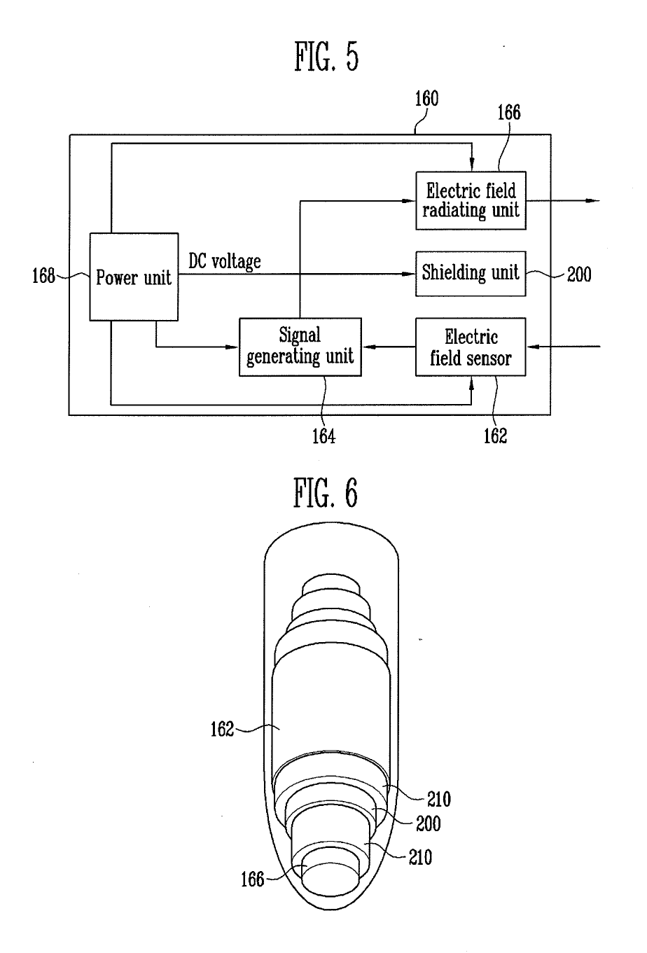

FIG. 1.

FIG. 3A is a sectional view of a sensing cell in the condition of a normal state (no touch).

FIG. 3B is a view schematically showing a sensed result based on a driving signal applied to each sensing cell in FIG. 3A.

FIG. 4A is a sectional view of a sensing cell in the condition of a contact by a finger.

FIG. 4B is a view schematically showing a sensed result based on a driving signal applied to each sensing cell in FIG. 4A.

FIG. 5 is a block diagram showing the configuration of an active stylus according to some embodiments.

FIG. 6 is a view showing the external appearance and internal structure of an end portion in the active stylus according to some embodiments.

FIG. 7A is a sectional view of a sensing cell in the condition of a contact by the active stylus according to some embodiments.

FIGS. 7B and 7C are views schematically showing a sensed result based on a driving signal applied to each sensing cell in FIG. 7A.

FIG. 8A is a sectional view of a sensing cell in contact by an active stylus according to some embodiments.

FIG. 8B is a view schematically showing a sensed result based on a driving signal applied to each sensing cell in FIG. 8A.

FIG. 9 is a block diagram showing the configuration of the active stylus according to some embodiments.

FIG. 10 is a block diagram showing the configuration of a sensing circuit according to some embodiments.

### DETAILED DESCRIPTION OF CERTAIN INVENTIVE EMBODIMENTS

Hereinafter, certain embodiments will be described with reference to the accompanying drawings. Here, where a first element is described as being coupled to a second element, the first element may be not only directly coupled to the second element but may also be indirectly coupled to the second element via a third element. Further, some of the elements that are not essential to the complete understanding of the invention are omitted for clarity. Also, like reference numerals refer to like elements throughout.

Hereinafter, various aspects and features will be described in detail with reference to the accompanying drawings.

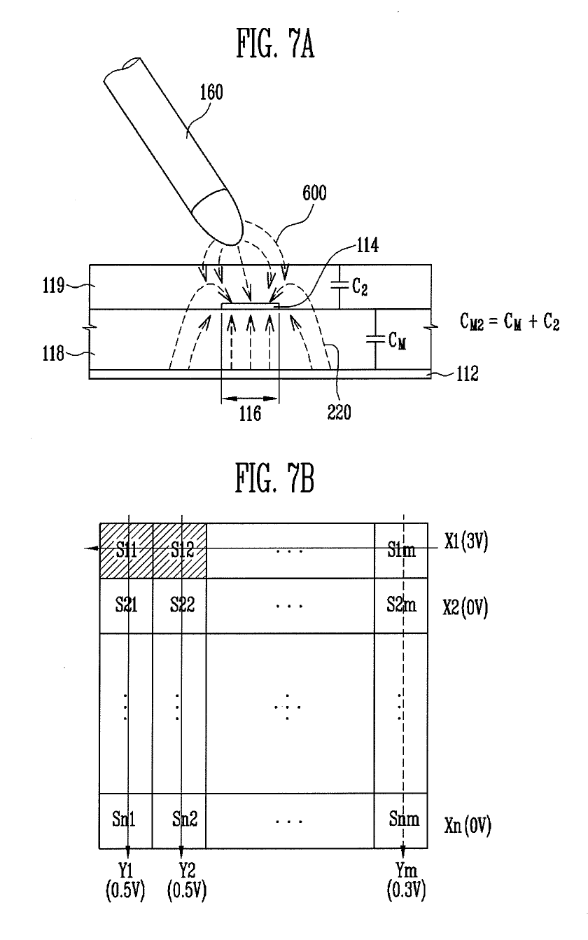

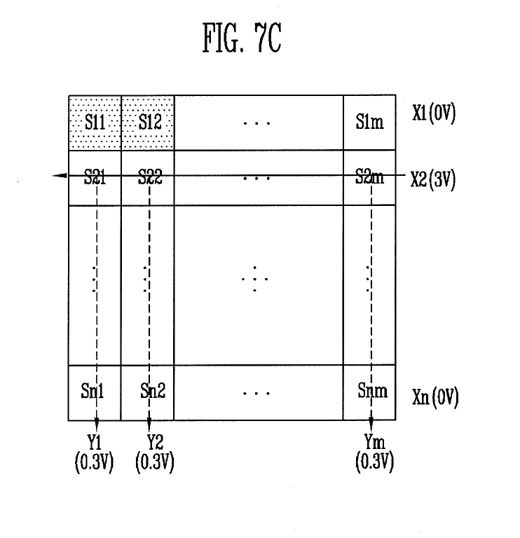

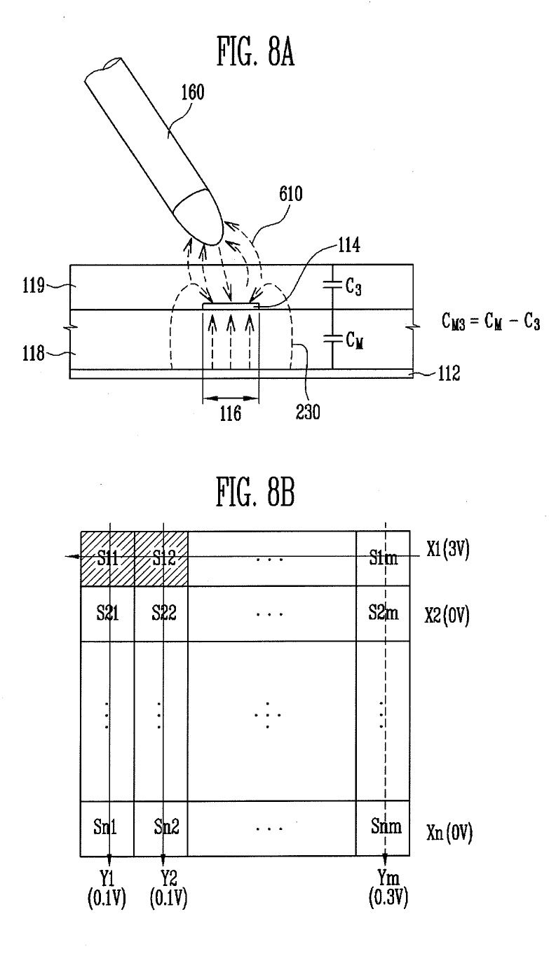

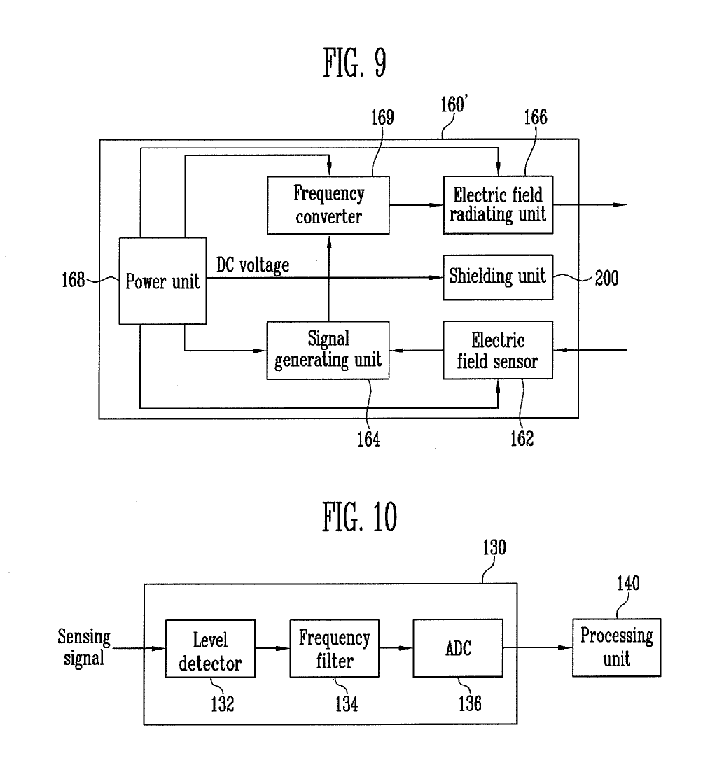

FIG. 1 is a block diagram of a touch screen system according to some embodiments. FIG. 2 is a simplified circuit diagram of the touch screen panel shown in FIG. The touch screen system 100 according to some embodiments includes a touch screen panel 110 including a plurality of driving lines 112 (X1, X2, X3 . . . and Xn) arranged in a first direction, a plurality of sensing lines 114 (Y1, Y2, Y3, Y4 . . . and Ym) may be arranged in a direction intersected with the driving lines 112, and a plurality of sensing cells 116 may be formed at intersection points of the driving and sensing lines 112 and 114. A driving circuit 120 may be configured to sequentially apply a driving signal to the driving lines 112. A sensing circuit 130 may be configured to detect a change in capacitance sensed from each of the sensing cells 114 and generate a sensing signal corresponding to the change in capacitance. A processing unit 140 may be configured to receive the sensing signal provided from the sensing circuit 130 to determine the detected touch position. An active stylus 160 may be used as an object to contact the touch screen panel 110.

In this instance, the active stylus 160 is configured separately from the touch screen panel 110. When the active stylus 160 approaches or contacts the touch screen panel 110, an electric field is generated in synchronization with a driving signal applied to a driving line 112 coupled to a sensing cell 116 adjacent to the contact position.

The plurality of driving lines 112 and the plurality of sensing lines 114 are formed in different layers on a transparent substrate (not shown), and may be made of a transparent conductive material. In one aspect, the transparent conductive material may be indium tin oxide (ITO), indium zinc oxide (IZO), carbon nano tube (CNT), or the like.

An insulating layer (now shown) that serves as a dielectric substance may be formed between the plurality of driving lines 112 and the plurality of sensing lines 114.

Although it has been described in the embodiment shown in FIG. 1 that the driving lines 112 and the sensing lines 114 are orthogonally intersected with each other, this description is provided only for illustrative purposes and is not limited thereto. That is, the driving lines 112 and the sensing lines 114 may have the intersection shape of another geometric configuration. For example, the driving lines 112 and the sensing lines 114 may be formed as concentric lines arranged in polar coordinates and radial lines, or the like.

A mutual capacitance (C_{M}) between the driving and sensing lines is formed at each of the intersection points of the driving lines 112 and the sensing lines 114, and each of the intersection points, at which the mutual capacitance is formed, serves as each of the sensing cells 116 for implementing touch recognition.

In a case where a driving signal from the driving circuit 120 is applied to the driving line 112 coupled to each of the sensing cells 116, a sensing signal subjected to coupling to the sensing line 114 coupled to each of the sensing cells 116 is generated by the mutual capacitance generated in each of the sensing cells 116.

That is, in a case where a driving signal is applied to the driving line coupled to each of the sensing cells 116, the mutual capacitance generated in each of the sensing cells 116 is sensed through the sensing line coupled to each of the sensing cells 116.

The driving circuit 120 sequentially provides a driving signal to each of the driving lines X1, X2, X3 . . . and Xn. Therefore, in a case where the driving circuit 120 the driving signal to any one of the driving lines X1, X2, X3 . . . and Xn, the other driving lines maintains a ground state.

Thus, mutual capacitances are respectively formed at a plurality of intersection points, i.e., sensing cells by a plurality of sensing lines intersected with the driving line to which the driving signal is applied. In a case where a finger 150 or stylus 160 comes in contact with each of the sensing cells, a change in capacitance is generated in the corresponding sensing cell.

As shown in FIG. 2, the touch screen panel 110 according to some embodiments may be represented as a mutual capacitance circuit. The mutual capacitance circuit may include a driving line 112 and a sensing line 114, and the driving line 112 and the sensing line 114 may be spatially separated from each other, thereby forming a capacitive coupling node, such as a sensing cell 116. In one aspect, the driving line 112 is coupled to a driving circuit 120 represented as a voltage source, and the sensing line 114 is coupled to a sensing circuit 130.

The driving line 112 and sensing line 114 may include predetermined parasitic capacitances 112a and 114a, respectively.

As described above, in a case where there is no conductive object (finger 150 or stylus 160) that approaches the intersection point of the driving and sensing lines 112 and 114, i.e., the sensing cell 116, there is no change in mutual capacitance C_{M} generated in the sensing cell 116. In a case where a conductive object approaches or contacts the sensing cell 116, a change in mutual capacitance is generated. As a result, the change in mutual capacitance changes current (and/or voltage) provided to the sensing line 114 coupled to the sensing cell 116.

Accordingly, the sensing circuit 130 coupled to the sensing line 114 converts information (sensing signal) on the change in capacitance and the position of the sensing cell 116 into a predetermined form through an Analog to Digital Converter (ADC), not shown, and transmits it to the processing unit 140.

An embodiment of a method for detecting the position of the sensing cell 116 in which the change in capacitance is generated will be described as follows.

If the sensing circuit 130 senses the change in capacitance in the sensing line 114 coupled to the sensing cell 116, it outputs the coordinate of the sensing line 114 in which the change in capacitance is generated and the coordinate of the driving line 112 corresponding to a driving signal is input from the driving circuit 120. For example, the sensing circuit 130 outputs the coordinate of the driving line 112 coupled to the sensing cell 116, so as to obtain the coordinate of at least one sensing cell contacted by the conductive object.

The sensing circuit 130 is coupled to the driving circuit 120 through a line (not shown) or the like. The driving circuit 120 scans (sequentially applies a driving signal) the driving lines 112 and simultaneously outputs the coordinates of the scanned driving lines to the sensing circuit 130 in succession, so that the sensing circuit 130 can sense a change in capacitance in the sensing line 114 and simultaneously obtain the point at which the capacitance is changed. For example, the sensing circuit 130 may output the position coordinate of the driving line 112 corresponding to the sensing cell 116.

Through the configuration described above, the touch screen system according to this embodiment can implement recognition for a plurality of contact points, i.e., multi-touch recognition.

Also, the touch screen system according to some embodiments can simultaneously implement multi-touch recognition by the user's finger 150 and multi-touch recognition by the active stylus 160.

That is, in order to overcome the problem that it is difficult to recognize a more precise contact position through the contact by a user's finger, the multi-touch recognition can be implemented even by using an active stylus that has a small area contacted with a touch panel and generating an electric field by itself.

However, in the case of the conventional active stylus that continuously generates an electric field and radiates the generated electric field, the continuously radiated electric field has influence not only on a sensing cell corresponding to an actual contact position but also on another sensing cell not contacted with the conventional active stylus. Therefore, it is difficult to detect a precise contact position.

Accordingly, in this embodiment, in a case where the active stylus approaches (or contacts) a specific sensing cell, the electric field is amplified/outputted in synchronization with a driving signal applied to a driving line coupled to the sensing cell, thereby overcoming the detection problem.

That is, when the active stylus 160 according to some embodiments contacts specific sensing cells 116 of the touch screen panel 110, it senses the contact and generates an electric field only in a case where a driving signal is applied to the sensing cells. Thus, the generated electric field has no influence on other sensing cells except the contacted sensing cells, so that it is possible to implement multi-touch recognition even by using the active stylus.

In some embodiments, the change in mutual capacitance, generated in the contact of the finger 150, is different from the change in mutual capacitance, generated in the contact of the active stylus 160. Thus, the changes in mutual capacitance are distinguished and processed in the sensing circuit 130 and the processing unit 140, so that it is possible to implement multi-touch recognition in various manners.

The operation of some embodiments will be described in a more detailed manner with reference to FIGS. 3 to 9.

First, the touch recognition by a finger contact will be described with reference to FIGS. 3A to 4B.

FIG. 3A is a sectional view of a sensing cell in the condition of a normal state (no touch). FIG. 3B is a view schematically showing a sensed result based on a driving signal applied to each sensing cell in FIG. 3A.

Referring to FIG. 3A, there are shown electric field lines 200 for mutual capacitances between a driving line 112 and a sensing line 114, separated from each other by an insulating layer 118 as a dielectric substance. A protection layer 119 is formed on the sensing line 114.

In some aspects, the point at which the driving and sensing lines 112 and 114 are intersected with each other is a sensing cell 116. As shown in FIG. 3A, a mutual capacitance C_{M} is formed between the driving and sensing lines 112 and 114, corresponding to the sensing cell 116.

However, the mutual capacitance C_{M} generated in each of the sensing cells 116 is generated in a case where a driving signal from the driving circuit 120 is applied to the driving line 112 coupled to each of the sensing cells 116.

That is, referring to FIG. 3B, the driving circuit 120 sequentially provide a driving signal (e.g., a voltage of 3V) to each of the driving lines X1, X2, . . . and Xn. In a case where the driving circuit 120 provides the driving signal to any one of the driving lines X1, X2, . . . and Xn, the other driving lines maintain a ground state. In FIG. 3B, it will be described as an example that the driving signal is applied to the first driving line X1.

Thus, mutual capacitances are respectively formed at a plurality of intersection points by a plurality of sensing lines intersected with the first driving line X1 to which the driving signal is applied, i.e., sensing cells S11, S12, . . . and S1m. Accordingly, a voltage (e.g., 0.3V) corresponding to the mutual capacitance is sensed from sensing lines Y1, Y2, Ym coupled to each of the sensing cells to which the driving signal is applied.

FIG. 4A is a sectional view of a sensing cell in the condition of a contact by a finger. FIG. 4B is a view schematically showing a sensed result based on a driving signal applied to each sensing cell in FIG. 4A.

Referring to FIG. 4A, if a finger 150 contacts at least one sensing cell 116, it is a low impedance object and has an AC capacitance C₁ from the sensing line 114 to a human body. The human body has a self capacitance of about 200 pF with respect to a ground, and this self capacitance is much greater than that of C₁.

In a case where an electric field line 210 between the driving and sensing lines 112 and 114 are shielded due to the contact of the finger 150, the electric field line 210 is branched to the ground through a capacitance path that exists in the finger 150 and the human body, and as a result, the mutual capacitance C_{M} in the normal state shown in FIG. 4A is decreased by C₁ such that C_{M1}=C_{M}−C₁.

Also, the change in mutual capacitance in each of the sensing cells changes the voltage provided to the sensing line 114 coupled to the sensing cell 116.

That is; as shown in FIG. 4B, the driving circuit 120 sequentially provides a driving signal (e.g., a voltage of 3V) to each of the driving lines X1, X2, . . . and Xn, so that mutual capacitances C_{M} are respectively formed in the plurality of sensing cells S11, S12, . . . and S1m by the plurality of sensing lines intersected with the first driving line X1 to which the driving signal is applied. In a case where one or more sensing cells (e.g., S12 and S1m) are contacted by the finger 150, the mutual capacitance is decreased (C_{M1}), and therefore, a voltage (e.g., 0.1V) corresponding to the decreased mutual capacitance is sensed from sensing lines Y2 and Ym respectively coupled to the contacted sensing cells S12 and S1m.

However, since the existing mutual capacitance C_{M} is maintained in the other sensing cells which are coupled to the first driving line X1 but are not contacted by the finger 150, the existing voltage (e.g., 0.3V) is sensed from sensing lines respectively coupled to the other sensing cells.

The sensing circuit 130 coupled to the sensing lines Y1, Y2, . . . and Ym converts the change in capacitance for the contacted sensing cells S12 and S1m and processes information (a sensing signal) regarding the positions of the contacted sensing cells S12 and S1m into a predetermined form through the ADC (not shown) and transmits it to the processing unit 140.

Since the embodiment of the method for detecting the position of the sensing cell 116 in which the change in capacitance is generated has been described with reference to FIG. 1, it will be omitted. Through the configuration described above, it is possible to implement recognition for a plurality of contact points by a finger, i.e., multi-touch recognition.

However, in a case where a touch is performed using the finger 150 as shown in FIG. 4A, the contact area is generally about 6 mm, which is greater than the area of the sensing cell. Therefore, in a case where the finger 150 is used, it is difficult to recognize a more precise touch.

In the case of a passive stylus having a sharp end, i.e., a passive stylus implemented as a simple conductor, a contact area of the passive stylus is small, and hence a change in capacitance at the contact area is extremely small. Therefore, it is difficult to detect the contact position of the passive stylus.

Accordingly, in this embodiment, it is possible to implement multi-touch recognition using a finger and to implement multi-touch recognition using an active stylus capable of performing a precise touch because of a smaller contact area than that of the finger, thereby overcoming such a problem.

As described above, since the conventional active stylus has a configuration that continuously generates an electric field and radiates it, the continuously radiated electric field has influence not only on a sensing cell corresponding to an actual contact position but also on another sensing cell not contacted with the conventional active stylus. Therefore, it is difficult to detect a precise contact position.

Accordingly, in some embodiments, in a case where the active stylus approaches (or contacts) a specific sensing cell, the electric field is amplified/outputted in synchronization with a driving signal applied to a driving line coupled to the sensing cell.

FIG. 5 is a block diagram showing the configuration of an active stylus according to some embodiments. FIG. 6 is a view showing the external appearance and internal structure of an end portion in the active stylus according to some embodiments.

Referring to FIG. 5, the active stylus 160 according to some embodiments includes an electric field sensor 162 configured to sense an electric field generated by a driving signal applied to a driving line contacted (or approached) by the active stylus 160. A signal generating unit 164 may be configured to generate a predetermined signal, i.e., an AC voltage for generating a separate electric field corresponding to the electric field sensed by the electric field sensor 162. An electric field radiating unit 166 may be configured to amplify the signal generated from the signal generating unit 164 and output the generated signal as an electric field. A power unit 168 may apply power to each of the components 162, 164 and 166.

The active stylus 160 further includes a shielding unit 200 that receives a predetermined DC voltage applied from the power unit 168 and shields an electric field for forming a closed loop between the electric field sensor 162 and the electric field radiating unit 166.

Here, the electric field sensor 162 corresponds to an input unit of the active stylus 160 according to some embodiments, and may include a coil so as to sense an electric field generated based on the application of a driving signal. That is, if the electric field sensor 162 is positioned in the region in which the electric field generated by the driving signal is formed, it can sense an electric force by the electric field.

If an electric field is sensed by the electric field sensor 162, the signal generating unit 164 generates a predetermined signal corresponding to the sensed electric field. That is, the signal generating unit 164 may generate an AC voltage having the same phase with the driving signal.

Then, the signal generated from the signal generating unit 164 is amplified and output through the electric field radiating unit 166.

Here, the electric field radiating unit 166 corresponds to an output unit of the active stylus according to some embodiments. The electric field radiating unit 166 may be implemented as a non-inverting amplifier that outputs the generated AC voltage by amplifying only the level (amplitude) of the AC voltage while maintaining the phase of the AC voltage as it is. Alternatively, the electric field unit 166 may be implemented as an inverting amplifier that outputs the generated AC voltage by inverting the phase of the AC voltage.

When the active stylus 160 according to some embodiments contacts specific sensing cells 116 of the touch screen panel 110, it senses the contact and generates an electric field only in a case where a driving signal is applied to the sensing cells. Thus, the generated electric field has no influence on other sensing cells except the contacted sensing cells, i.e., other sensing cells coupled to driving lines in a ground state, so that it is possible to implement multi-touch recognition even by using the active stylus.

In the active stylus 160 according to some embodiments, the area of the end portion that contacts the touch panel is implemented as a small area as shown in FIG. 6, and the input unit (electric field sensor) 162 and the output unit (electric field radiating unit) 166 are formed to be positioned at the end portion.

Therefore, the input unit 162 and the output unit 166 are respectively implemented as a conductor, and are physically positioned considerably adjacent to each other. This results in generating a closed loop between the input unit 162 and the output unit 166.

The closed loop between the input unit 162 and the output unit 166 causes the oscillation or amplitude decrease of an output signal output from the output unit 166.

In some embodiments, in order to solve such a problem, a shielding unit 200 may be formed between the input unit 162 and the output unit 166 as shown in FIG. 6.

Here, the shielding unit 200 is implemented as a conductor and formed in a region in which the input unit 162 and the output unit 166 are overlapped with each other. Since the shielding portion 200 is implemented as a conductor, insulating layers 210 is formed between the shielding unit 200 and the input unit 162 and between the shielding unit 200 and the output unit 166, respectively.

As shown in FIG. 5, the shielding unit 200 receives a predetermined DC voltage applied from the power unit 168. In this instance, the DC voltage may be high-level first power (VDD), low-level second power (VSS) or ground power (GND).

Through the configuration described above, the oscillation or amplitude decrease of the output signal outputted from the output unit 166 can be reduced by shielding the electric field caused by the closed loop formed between the input unit 162 and the output unit 166, which are physically adjacent to each other.

FIG. 7A is a sectional view of a sensing cell in the condition of a contact by the active stylus according to some embodiments. FIGS. 7B and 7C are views schematically showing a sensed result based on a driving signal applied to each sensing cell in FIG. 7A.

In FIG. 7A, an example of an electric field output from the active stylus and amplified by the non-inverting amplifier will be described. Since a non-contact state of the active stylus is identical to that described in FIGS. 3A and 3B, its description will be omitted.

A change in mutual capacitance in the sensing cell 116, caused by a contact of the active stylus 160, in the state that a driving signal is applied to the driving line 112 will be described with reference to FIG. 7A.

If the active stylus 160 contacts at least one sensing cell 116, it senses an electric field generated by the driving signal to the driving line 112 coupled to the sensing cell 116 and then amplifies/outputs an electric field corresponding to the sensed electric field.

In FIG. 7A, first electric field lines 220 are caused by an electric field generated by the application of the driving signal, and second electric field lines 600 are caused by an electric field outputted from the active stylus 160.

In this instance, the electric field outputted from the active stylus 160 is caused by an AC voltage output from the non-inverting amplifier. The AC voltage is an AC voltage having the same phase as the driving signal, corresponding to the sensed electric field, i.e., the electric field generated by the application of the driving signal.

Accordingly, as shown in this figure, the first electric field lines 220 are formed in a direction from the driving line 112 to the sensing line 114, and the second electric field lines 600 are formed in a direction from the active stylus 160 to the sensing line 114.

That is, as shown in this figure, a mutual capacitance C_{M} is formed between the driving line 112 and the sensing line 114, and an AC capacitance C₂ is formed between the sensing line 114 and the active stylus 160, corresponding to the sensing cell 116.

Thus, if the active stylus 160 contacts the sensing cell 116, the mutual capacitance C_{M} in a normal state (non-contact state) is increased by the C₂, such that CM2=C_{M}+C₂.

Consequently, the change in mutual capacitance in each of the sensing cells changes the voltage provided to the sensing line 114 coupled to the sensing cell 116.

That is, referring to FIG. 7B, the driving circuit 120 sequentially provides a driving signal (e.g., a voltage of 3V) to each of the driving lines X1, X2, . . . and Xn. In a case where the driving circuit 120 provides the driving signal to any one of the driving lines X1, X2, . . . and Xn, the other driving lines maintain a ground state. In FIG. 7B, an example of the driving signal applied to the first driving line X1 will be described.

Mutual capacitances C_{M} are respectively formed in the plurality of sensing cells S11, S12, . . . and S1m by the plurality of sensing lines intersected with the first driving line X1 to which the driving signal is applied. In a case where one or more sensing cells (e.g., S11 and S12) are contacted by the active stylus 160, the mutual capacitance is increased (C_{M2}), and therefore, a voltage (e.g., 0.5V) corresponding to the increased mutual capacitance is sensed from sensing lines Y1 and Y2 respectively coupled to the contacted sensing cells S11 and S11.

However, since the existing mutual capacitance C_{M} is maintained in the other sensing cells which are coupled to the first driving line X1 but are not contacted by the active stylus 160, the existing voltage (e.g., 0.3V) is sensed from sensing lines respectively coupled to the other sensing cells.

The operation of the active stylus 160 will be described in a more detailed manner. Referring to FIG. 7C, it is assumed that the active stylus 160 contacts the sensing cells S11 and S12 coupled to the first driving line X1, but the driving signal is applied to the second driving line X2 rather than the first driving line X1.

In this case, since the driving signal is not applied to the driving line X1 coupled to the sensing cells S11 and S12 contacted by the active stylus 160, the active stylus 160 senses no electric field and therefore, does not output a separate electric field.

Since the active stylus 160 is a simple conductor, touch recognition is not performed. That is, a voltage (e.g., 0.3V) corresponding the existing mutual capacitance C_{M} is sensed from the sensing lines Y1, Y2, . . . and Ym.

However, in a case where the active stylus 160 is not synchronized with a driving signal but outputs an electric field like the conventional active stylus, it is erroneously sensed that the active stylus 160 contacts the sensing cells S21 and S22, which are not substantially contacted by the active stylus 160.

Consequently, when the active stylus 160 according to some embodiments contacts specific sensing cells 116 of the touch screen panel 110, it senses the contact and generates an electric field only in a case where a driving signal is applied to the sensing cells. Thus, the generated electric field has no influence on other sensing cells except the contacted sensing cells, i.e., other sensing cells coupled to driving lines in a ground state, so that it is possible to implement multi-touch recognition even by using the active stylus.

Then, the sensing circuit 130 coupled to the sensing lines Y1, Y2, . . . and Ym converts the change in capacitance for the contacted sensing cells S12 and S1m and information (sensing signal) on the positions of the contacted sensing cells S12 and S1m into a predetermined form through the ADC (not shown) and transmits it to the processing unit 140.

Since embodiments of the method for detecting the position of the sensing cell 116 in which the change in capacitance is generated has been described with reference to FIG. 1, it will be omitted. Through the configuration described above, it is possible to implement recognition for a plurality of contact points by the active stylus 160, i.e., multi-touch recognition.

FIG. 8A is a sectional view of a sensing cell in a contact by an active stylus according to some embodiments. FIG. 8B is a view schematically showing a sensed result based on a driving signal applied to each sensing cell in FIG. 8A.

In FIG. 8A, an example of an electric field output from the active stylus and amplified by an inverting amplified will be described. Since the non-contact state of the active stylus is identical to that described in FIGS. 3A and 3B, its description will be omitted.

A change in mutual capacitance in the sensing cell 116, caused by a contact of the active stylus 160, in the state that a driving signal is applied to the driving line 112 will be described with reference to FIG. 8A.

If the active stylus 160 contacts at least one sensing cell 116, it senses an electric field generated by the driving signal to the driving line 112 coupled to the sensing cell 116 and then amplifies/outputs an electric field corresponding to the sensed electric field.

In FIG. 8A, first electric field lines 230 are caused by an electric field generated by the application of the driving signal, and second electric field lines 610 are caused by an electric field outputted from the active stylus 160.

In this instance, the electric field outputted from the active stylus 160 is caused by an AC voltage outputted from the inverting amplifier. The AC voltage is an AC voltage having the opposite phase to the driving signal, corresponding to the sensed electric field, i.e., the electric field generated by the application of the driving signal.

Accordingly, as shown in this figure, the first electric field lines 230 are formed in a direction from the driving line 112 to the sensing line 114, and the second electric field lines 610 are formed in a direction from the sensing line 114 to the active stylus 160.

That is, the direction of the second electric field lines 610 is formed opposite to that of the second electric field lines 600 of FIG. 7A.

Thus, a mutual capacitance C_{M} is formed between the driving line 112 and the sensing line 114, and an AC capacitance C₃ is formed between the sensing line 114 and the active stylus 160. If the active stylus 160 contacts the sensing cell 116, the mutual capacitance C_{M} in a normal state (non-contact state) is decreased by the C₃ such that C_{M3}=C_{M}−C₃.

Consequently, the change in mutual capacitance in each of the sensing cells changes the voltage provided to the sensing line 114 coupled to the sensing cell 116.

That is, referring to FIG. 8B, the driving circuit 120 sequentially provides a driving signal (e.g., a voltage of 3V) to each of the driving lines X1, X2, . . . and Xn. In a case where the driving circuit 120 provides the driving signal to any one of the driving lines X1, X2, . . . and Xn, the other driving lines maintain a ground state. In FIG. 8B, it will be described as an example that the driving signal is applied to the first driving line X1.

Mutual capacitances C_{M} are respectively formed in the plurality of sensing cells S11, S12, . . . and S1m by the plurality of sensing lines intersected with the first driving line X1 to which the driving signal is applied. In a case where one or more sensing cells (e.g., S11 and S12) are contacted by the active stylus 160, the mutual capacitance is decreased (C_{M3}), and therefore, a voltage (e.g., 0.1V) corresponding to the decreased mutual capacitance is sensed from sensing lines Y1 and Y2 respectively coupled to the contacted sensing cells S11 and S11.

However, since the existing mutual capacitance C_{M} is maintained in the other sensing cells which are coupled to the first driving line X1 but are not contacted by the active stylus 160, the existing voltage (e.g., 0.3V) is sensed from sensing lines respectively coupled to the other sensing cells.

Then, the sensing circuit 130 coupled to the sensing lines Y1, Y2, . . . and Ym converts the change in capacitance for the contacted sensing cells S12 and S12 and information (i.e. a sensing signal) on the positions of the contacted sensing cells S12 and S1m into a predetermined form through the ADC (not shown) and transmits it to the processing unit 140.

Since embodiments of the method for detecting the position of the sensing cell 116 in which the change in capacitance is generated has been described with reference to FIG. 1, it will be omitted. Through the configuration described above, it is possible to implement recognition for a plurality of contact points by the active stylus 160, i.e., multi-touch recognition.

In some embodiments, the change in mutual capacitance, generated in the contact of the finger 150, is different from the change in mutual capacitance, generated in the contact of the active stylus 160. Thus, the changes in mutual capacitance are distinguished and processed in the sensing circuit 130 and the processing unit 140, so that it is possible to implement multi-touch recognition in various manners.

That is, although the contacts of the finger 150 and the active stylus 160 are simultaneously performed, they are distinguished and recognized.

Particularly, in the embodiments described in FIG. 7, in a case where the active stylus 160 outputs an AC signal having the same phase as the driving signal through the non-inverting amplifier, the level (e.g., 0.5V) of the sensing signal sensed by the sensing line is considerably different from the level (e.g., 0.2V) of the sensing signal sensed by the contact of the finger 150. Thus, the contacts of the active stylus 160 and the finger 150 can be distinguished, for example, by providing a level detector (not shown) and/or a level comparator (not shown).

However, in the embodiment described in FIG. 8, in a case where the active stylus 160 outputs an AC signal having a different phase from the driving signal through the inverting amplifier, the level (e.g., 0.1V) of the sensing signal sensed by the sensing line is hardly different from the level (e.g., 0.2V) of the sensing signal by the contact of the finger 150. Therefore, it may be difficult to distinguish the contact of the active stylus 160 from the contact of the finger 150.

Accordingly, in some embodiments, the configuration of the active stylus 160 and the sensing circuit 130 is changed, thereby solving such a problem.

FIG. 9 is a block diagram showing the configuration of the active stylus according to some embodiments. FIG. 10 is a block diagram showing the configuration of a sensing circuit according to some embodiments.

The configuration of the active stylus may be identical to that of the active stylus shown in FIG. 5, except that a frequency converter is additionally provided. Therefore, like reference numerals refer to like elements, and their detailed descriptions will be omitted.

Referring to FIG. 9, the active stylus 160′ according to some embodiments includes an electric field sensor 162 as an input unit that senses an electric field generated by a driving signal applied to a driving line contacted (or approached) by the active stylus 160. A signal generating unit 164 may be configured as an input unit that generates a predetermined signal, i.e., an AC voltage for generating a separate electric field corresponding to the electric field sensed by the electric field sensor 162. An electric field radiating unit 166 may be configured as an output unit that amplifies the signal generated from the signal generating unit 164 and outputs the generated signal as an electric field. A power unit 168 that applies power to each of the components 162, 164 and 166; and a shielding unit 200 may be configured to receive a predetermined DC voltage applied from the power unit 168 and shields an electric field for forming a closed loop between the electric field sensor 162 and the electric field radiating unit 166. The active stylus 160 is further provided with a frequency converter 169 that converts a signal generated from the signal generating unit 164, i.e., the frequency of an AC voltage.

In this case, the electric field radiating unit 166 may be implemented as an inverting amplifier that inverts the phase of the generated AC voltage and then outputs it.

The frequency converter 169 is additionally configured to overcome the problem that in a case where the active stylus 160 outputs an AC signal having a different phase from the driving signal through the inverting amplifier 166, the level (e.g., 0.1V) of the sensing signal sensed by the sensing line is hardly different from the level (e.g., 0.2V) of the sensing signal sensed by the contact of the finger 150. Therefore, given the small difference in sensed voltage level, it is difficult to distinguish the contact of the active stylus 160 from the contact of the finger 150. Although the level of the sensing signal by the sensing line is similar to the level of the sensing signal sensed by the contact of the finger 150, the frequencies of the sensing signals are different from each other, and thus, it is possible to distinguish the contact of the active stylus 160 from the contact of the finger 150.

In this case, a frequency filter for detecting the converted frequency is necessarily provided to the sensing circuit 130 so as to detect that the frequencies are different from each other.

Accordingly, as shown in FIG. 10, the sensing circuit according to some embodiments includes a frequency filter 134.

That is, the sensing circuit 130 includes a level detector 132 that detects the levels of sensed signals; a frequency filter 134 that filters signals having a specific frequency among the sensed signals; and an analog-to-digital converter (ADC) 136 that converts the sensing signals passing through the level detector 132 and/or the frequency filter 134 into digital signals and provides the digital signals to the processing unit 140.

The level detector 132 functions to detect the level of a sensing signal, so that it is possible to distinguish the sensing signal sensed when a contact is performed using the active stylus 160 of FIG. 7 from the sensing signal sensed when a contact is performed using the finger 150.

The frequency filter 134 is implemented as a band pass filter for a specific frequency band so as to filter the frequency converted by the frequency converter 169 shown in FIG. 9. Accordingly, it is possible to distinguish the sensing signal sensed when a contact is performed using the active stylus 160 of FIGS. 8 and 9 from the sensing signal sensed when a contact is performed using the finger 150.

According to some embodiments, a shielding unit may be implemented as a conductor and formed in a region in which the electric field sensor and the electric field radiating unit are overlapped with each other. Insulating layers may be formed between the shielding unit and the electric field sensor and between the shielding unit and the electric field radiating unit, respectively.

The shielding unit may receive a predetermined DC voltage applied from the power unit. The DC voltage may be the voltage of one of high-level first power (VDD), low-level second power (VSS) or ground power (GND).

The predetermined signal may be an AC voltage having the same phase as the driving signal. The electric field radiating unit may be implemented as a non-inverting amplifier that outputs the predetermined signal generated from the signal generating unit by amplifying only the level (amplitude) of the predetermined signal while maintaining the phase of the predetermined signal as it is.

The electric field radiating unit may be implemented as an inverting amplifier that inverts the phase of the predetermined signal generated from the signal generating unit and outputs it. The active stylus may be further provided with a frequency converter that converts the frequency of the AC voltage generated from the signal generating unit.

According to some embodiments, an active stylus used in a mutual capacitive touch screen system, a shielding unit is formed to shield an electric field that forms a closed loop between input and output units of the active stylus, so that it is possible to remarkably decrease a closed loop gain that causes oscillation or amplitude decrease.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An active stylus for outputting an electric field in synchronization with a driving signal applied to a driving line coupled to an adjacent cell when the active stylus approaches or contacts a touch screen panel, the active stylus comprising:
an electric field sensor configured to sense an electric field generated by the driving signal applied to a specific driving line approached or contacted by the stylus;
a signal generating unit configured to generate a predetermined signal so that a separate electric field corresponding to the sensed electric field is generated;
an electric field radiating unit configured to amplify the signal generated from the signal generating unit and output the amplified signal as an electric field;
a shielding unit configured to shield an electric field for forming a closed loop between the electric field sensor and the electric field radiating unit; and
a power unit configured to apply power to each of the electric field sensor, the signal generating unit, the electric field radiating unit and the shielding unit.

2. The active stylus according to claim 1, wherein the shielding unit is implemented as a conductor and formed in a region in which the electric field sensor and the electric field radiating unit overlap with each other.

3. The active stylus according to claim 2, wherein insulating layers are formed between the shielding unit and the electric field sensor and between the shielding unit and the electric field radiating unit, respectively.

4. The active stylus according to claim 1, wherein the shielding unit receives a predetermined DC voltage from the power unit.

5. The active stylus according to claim 4, wherein the DC voltage is one of high-level first power (VDD), low-level second power (VSS) or ground power (GND).

6. The active stylus according to claim 1, wherein the predetermined signal is an AC voltage having the same phase as the driving signal.

7. The active stylus according to claim 1, wherein the electric field radiating unit is implemented as a non-inverting amplifier configured to output the predetermined signal generated from the signal generating unit by amplifying only the level or amplitude of the predetermined signal while maintaining the phase of the predetermined signal as is.

8. The active stylus according to claim 1, wherein the electric field radiating unit is implemented as an inverting amplifier configured to invert the phase of the predetermined signal generated by the signal generating unit and output the inverted signal.

9. The active stylus according to claim 8, wherein the active stylus is further provided with a frequency converter configured to convert the frequency of the AC voltage generated by the signal generating unit.
